(19) United States
(12) Patent Application Publication
(10) Pub. No.: US 2011/0100945 A1
(43) Pub. Date: May 5, 2011

(54) Vent system for a dispensing unit

(76) Inventor: Henry Alfonso Gutierrez, Lawrenceville, GA (US)

(21) Appl. No.: 12/924,269

(22) Filed: Sep. 22, 2010

Related U.S. Application Data
(60) Provisional application No. 61/277,412, filed on Sep. 24, 2009.

(51) Int. Cl. A61J 9/04

(52) U.S. Cl. 215/11.5; 222/188

(57) ABSTRACT

A vent system for a bottle dispenser. The vent system including a nipple, a ring and a capillary tube. The ring is disposed adjacent to the nipple and secured to the dispenser by a collar. The capillary tube disposed in an aperture that allows atmospheric air to pass into the dispenser, and prevents moisture from escaping out of the dispenser. The aperture may be disposed within a thickness in a wall of the nipple or the ring.

### CROSS REFERENCE TO RELATED APPLICATION

This application is a Provisional which claims the benefit of the filing date of U.S. Provisional Application Ser. No. 60/763,433, entitled “Chambered Bottle for Storing, Mixing and Dispensing a Beverage Composed of a Predetermined Dosage of a First and Second Substance” filed Jun. 8, 2007, the entirety of which is incorporated herein. This application also incorporates the subject matter described in WO 2008/153965 A1.

### BACKGROUND

### Field of the Invention

The invention relates to a vent system for a compact, portable storing, mixing and/or dispensing unit that eliminates vacuum pressure in a nursing bottle.

### SUMMARY

In keeping with one aspect, a vent system for a container is provided. The object of this invention is to provide a vent system that allows atmospheric air to enter the container when the flowable material within the container is being removed to prevent a vacuum effect. The nipple includes a retaining aperture and the capillary tube is secured to the retaining aperture The vent system may be adapted for use with a container including chambers for storing a first substance (or composition) and a second substance (or composition).

In particular, the nipple has an aperture into which a capillary tube is disposed that allows atmospheric air to pass there-in, but prevents moisture from escaping there-out of.

A capillary tube may be disposed in either the nipple or a ring to allow the atmospheric air to pass there-in, while preventing moisture from escaping there-out of.

As such, the container may have an opening to secure a capillary tube, creating a vent system. This vent system includes capillary properties that allow outside air to enter the container and prevent the flowable material from escaping from the container through the capillary tube.

### BRIEF DESCRIPTION OF THE DRAWINGS

Various exemplary embodiments of this invention will be described in detail, wherein like reference numerals refer to identical or similar components or steps, with reference to the following figures. Likewise, some of the figures herein depict minimal line-work for ease of understanding.

FIG. 1 illustrates an exemplary side exploded perspective view of a multi-chamber container in accordance with this invention.

FIG. 2 illustrates an exemplary side exploded perspective view of a multi-chamber container including a vent system in which a capillary tube is attached to the nipple in accordance with this invention and an exemplary embodiment of the multi-chamber container showing plurality communication passageways are included in accordance with this invention.

FIG. 3 illustrates a section view of the multi-chamber container assembled in a closed position in accordance with this invention.

FIG. 4 illustrates a section view of the multi-chamber container assembled in an opened position in accordance with this invention.

FIG. 4a illustrates a partial section view of an exemplary embodiment of the multi-chamber container, in which a seal is disposed in a lower wall of an upper chamber and another seal is disposed in the upper wall of a lower chamber in accordance with this invention.

FIGS. 5a-5c illustrate section, upper perspective and bottom perspective views of the vent system, in accordance with this invention.

FIGS. 6a-6c illustrate section, upper perspective and bottom perspective views of an exemplary embodiment of the vent system in accordance with this invention.

FIG. 7a illustrate section view of an exemplary embodiment of the vent system, incorporating an adaptor on the bottom of the nipple in which the capillary tube is attached to the adaptor in accordance with this invention.

FIGS. 7b-7c illustrate an upper perspective and a section views of the adaptor in accordance with this invention.

FIG. 8 illustrates a section view of the vent system in accordance with this invention.

FIGS. 9a-10 illustrate, section, upper perspective and bottom perspective views of an exemplary embodiment of the vent system, in which an internal edge is incorporated to the nipple in accordance with this invention.

FIGS. 11a and 11b, illustrate upper perspective views of an exemplary embodiment of the vent system including a flange between the nipple and the adaptor in accordance with this invention.

### DETAILED DESCRIPTION OF EXEMPLARY EMBODIMENTS

Particular embodiments of the present invention, a vent system for a compact modular and portable chambered container adapted for a variety of different uses, such as for use to mix a variety of different ingredients will now be described in greater detail with reference to the figures.

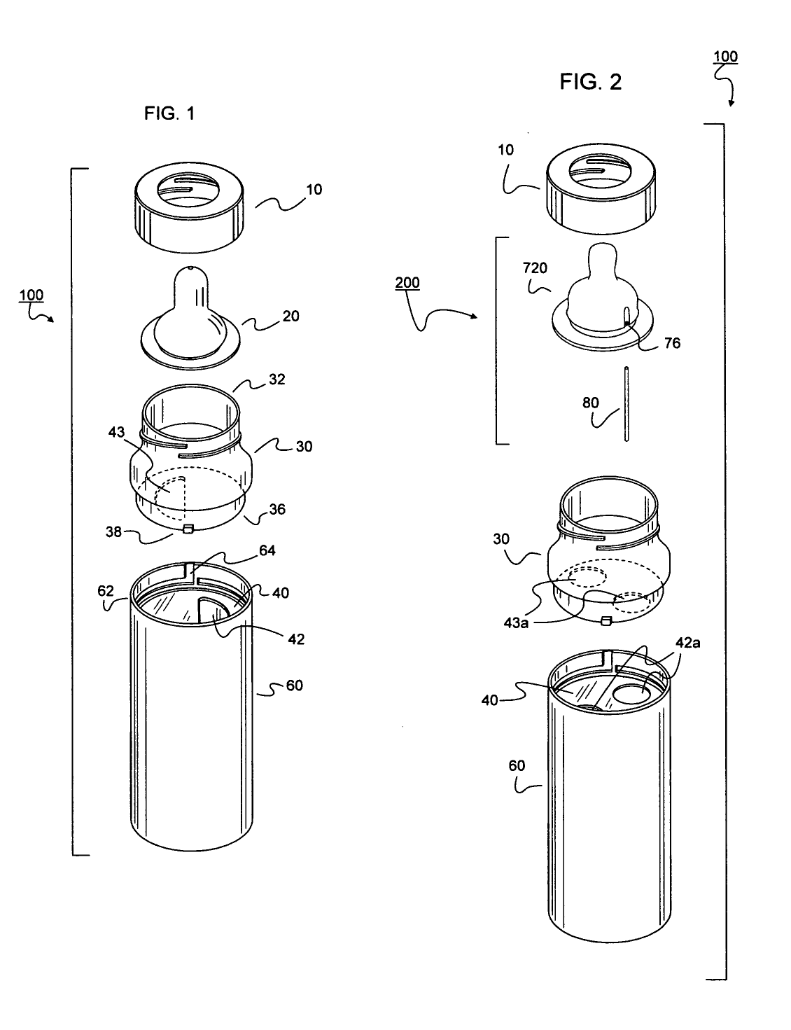

FIG. 1 illustrates an is an exploded view of an exemplary embodiment of the multi-chamber container configured as a multi-chamber infant nursing bottle 100. The nursing bottle 100 is constructed to separate, store, mix and dispense a baby formula beverage. In more detail, the nursing bottle 100 illustrates at a first open end 32 of an upper chamber (hereafter referred to as a bottle 30), a collar 10 adapted to secure and compress a nipple 20 to the first open end 32 of the bottle 30.

At a lower second open end 36 of the bottle 30, a lower chamber (hereafter referred to as a container 60) is provided and adapted to be secured to the lower second open end 36 of the bottle 30. A seal 40 is disposed adjacent to an open portion 62 of the container 60.

The lower second open end 36 of the bottle 30 includes an eccentric opening 43 similar in shape and size to an opening 42 in the seal 40. As will be described in more detail, the eccentric opening 43 of the bottle 30 and the opening 42 of the seal 40 are configured to overlap each other to form an opening 45 when the bottle and the container 60 are in an open position as shown in FIG. 4. Although openings 42 and 43 are shown as eccentric openings, it is to be understood that various sizes and shapes may be used in accordance with this invention.

Although snap-locks fasteners illustrating a pin 38 and a groove 64 arrangement are shown as the fastening mechanisms between the second open end 36 of the bottle 30 and the open portion 62 of the container 60, it is to be understood that various types of fastening mechanisms may be employed, such as for example, clip-locks, threads, detents and/or any other suitable type of fastening mechanism now known or later discovered in accordance with this invention.

The bottle 30 may hold a variety of different first substances, including but not limited to: a powdered formula (e.g., an infant formula), and/or any other type of liquid or powdered additive (such as tea, punch, sports hydration drink, and the like). Likewise, the container 60 may also be filled with any one of a variety of different second substance intended to be mixed with the first substance in the bottle to make a beverage, including but not limited to: a powder, a liquid, such as water.

Likewise, the multi-chambered device may be used for other purposes, such as for example, medicinal purposes where as such the dispensable material may be a predetermined dose composed from a first and/or or second substance that may be a reconstitutable powder, liquid and/or other ingredient form. For example, the powder or liquid may be a reconstitutable nutritional infant or adult formula.

FIG. 2 is an exploded view of the infant nursing bottle 100 including a vent system 200. The vent system 200 includes a modified nipple 720 and a tube 80. The tube 80 may be constructed to include suitable capillary properties to restrict and/or prevent the free flow of a liquid. However, the tube 80 is adapted to allow for the free flow of atmospheric air.

In use, one end 80a of the tube 80 may be secured to an aperture 76 in the modified nipple 720, as will be shown and described in more detail below. The capillary characteristics of the tube 80 are provided in the vent system 200 to allow atmospheric air to enter the infant nursing bottle 100 when liquid is removed through the modified nipple 720. Simultaneously, the capillary properties of the tube 80 will prevent any liquid from escaping from within the infant nursing bottle 100 through the tube 80.

FIG. 2 further shows an exemplary embodiment of the infant nursing bottle 100 including various openings 43a in the second open end 36 of the bottle 30 and various openings 42a in the seal 40. The various openings 43a, 42a are configured to overlap each other to form a through opening, i.e., to operate similar to the through opening 45 described in FIG. 1 and shown in FIG. 4.

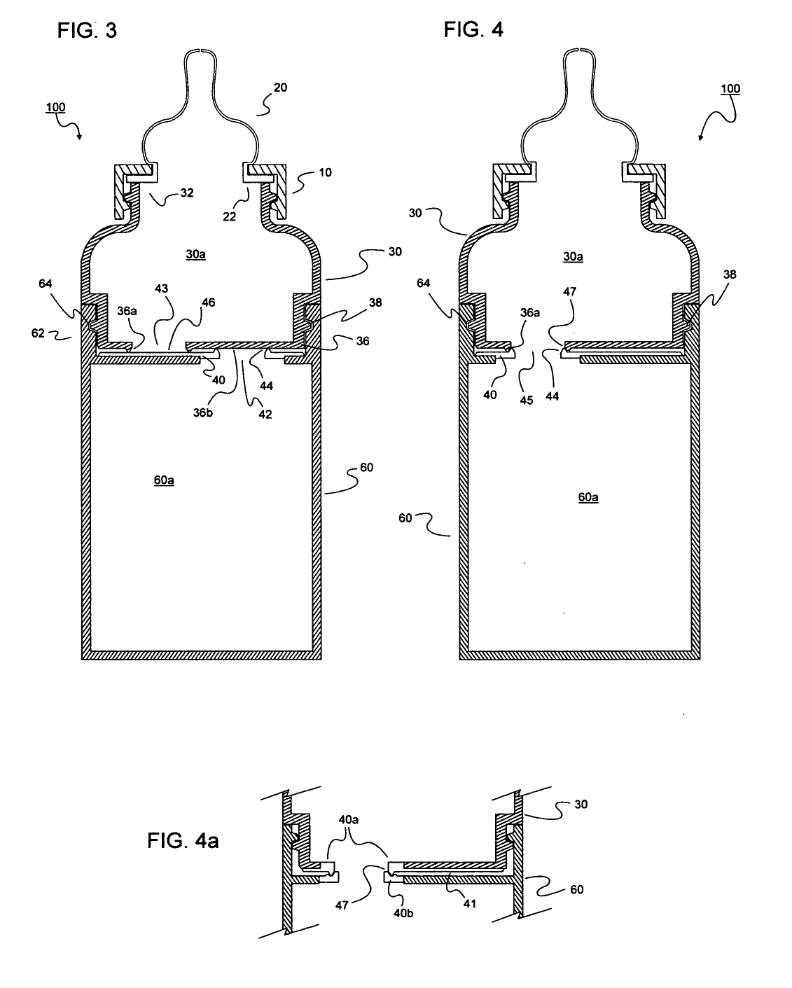

FIGS. 3 and 4 show a simple exemplary cross-section side view of an assembled illustration of the infant nursing bottle 100. In construction, the infant nursing bottle 100 shows the collar 10 securing a radial flange 22 of the nipple 20 to the first open end 32 of the bottle 30. In this position, the radial flange 22 of the nipple 20 fluidly seals the collar 10 to the bottle 30 in a moisture tight manner.

The seal 40 is shown disposed between the second lower end 36 of the bottle 30 and the open portion 62 of the container 60. The seal 40 is adapted to seal and prevent the leakage of fluid (and/or other substance) between the bottle 30 and the container 60. The seal is caused as a result of a compression force generated when the lower end 36 of the bottle 30 is fastened onto the container 60 via the pin 38 and groove 64 fastening mechanism.

FIG. 3 shows the assembly of the infant nursing bottle 100 in a storing position. The sealing and/or compression force that operates to seal the bottle 30 from the container 60 is translated to the edge 36a of the bottle 30 and the edge 44 of the seal 40. The edge 36a of the bottle 30 is urged against a surface portion 46 of the seal 40 and the edge 44 of the seal 40 is urged against the surface 36b of the bottle 30. In the closed position shown in FIG. 3, the seal 40 forms a liquid and/or substance tight seal at the connection joint between the bottle 30 and the container 60. In this closed position, the open area 30a of the bottle 30 and the open area 60a of the container 60 are separated and sealed off from each other.

In FIG. 4, the infant nursing bottle 100 is shown in a mixing position in which the various substances stored separately in the open area 30a of the bottle 30, and the open area 60a of the container 60 are allowed to be combined and mixed together.

In operation, the bottle 30 and the container 60 are twisted and/or rotated relative to each other from the storing position (as shown in FIG. 3) into the mixing position (as shown in FIG. 4) so that the eccentric opening 43 of the bottle 30 and the opening 42 in the seal 40 (as shown in FIG. 3) are aligned over each other to form a through opening 45. When the eccentric opening 43 of the bottle 30 and the opening 42 in the seal 40 are aligned, a first substance stored in the open area 30a of the bottle 30 and another second substance stored in the open area 60a of the container 60 are allowed to mix through the opening 45.

As shown in FIG. 4, the twisted or closing compression force is applied to and/or translated to the edge 36a of the bottle 30, urging against the edge 44 of the seal 40, so that the seal 40 may form a liquid tight seal at this connection joint 47 between the bottle 30 and the container 60.

FIG. 4a shows another exemplary embodiment of the multi chamber container 100, in which two seals 40a and 40b are located between the connection joint 47 between the bottle 30 and the container 60. As shown, a first seal 40b is attached to the upper end of the container 60. And, a second seal 40a is disposed at the lower end of the bottle 30. In use, the second seal 40a and the first seal 40b operate similar to the operation shown in FIG. 3 and FIG. 4 where only one seal 40 is present. FIG. 4a is shows an exemplary embodiment for the seal 40, in which the seal 40a is integrated and/or attached to the edge of the eccentric opening 43 of the upper container. One of ordinary skill in the art would understand that various configurations for a seal at the connection joint 47 are possible in accordance with this invention.

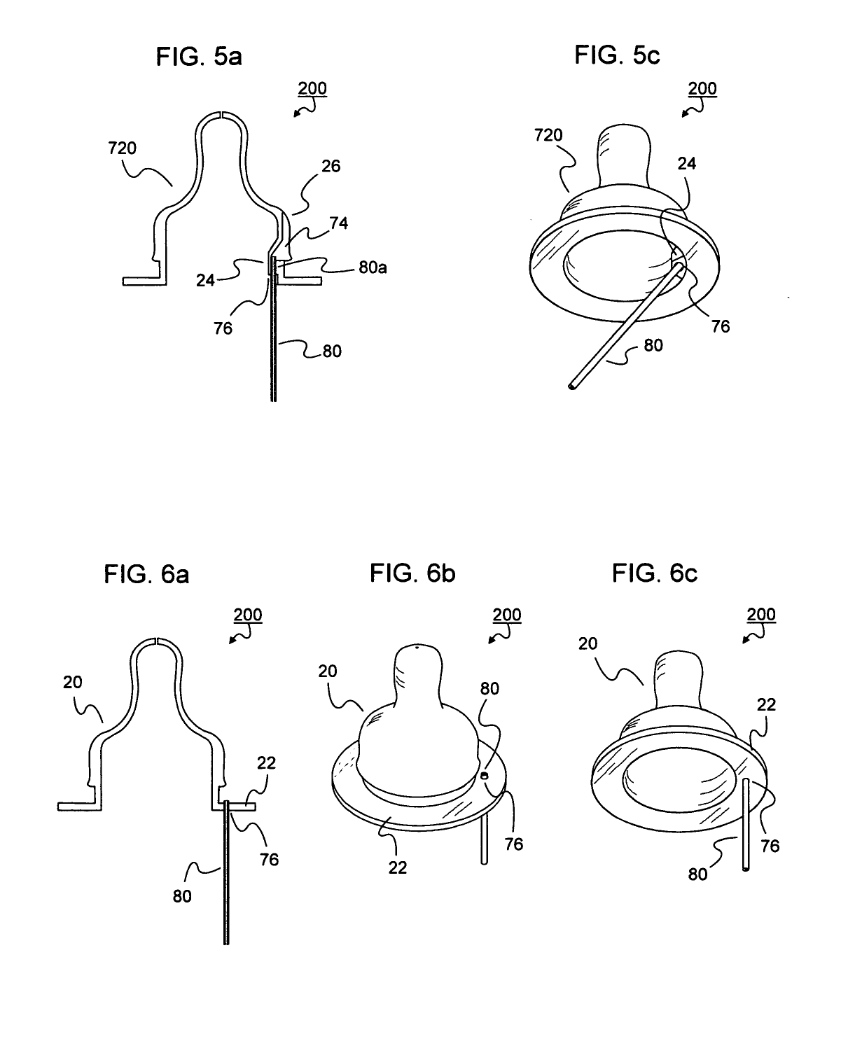

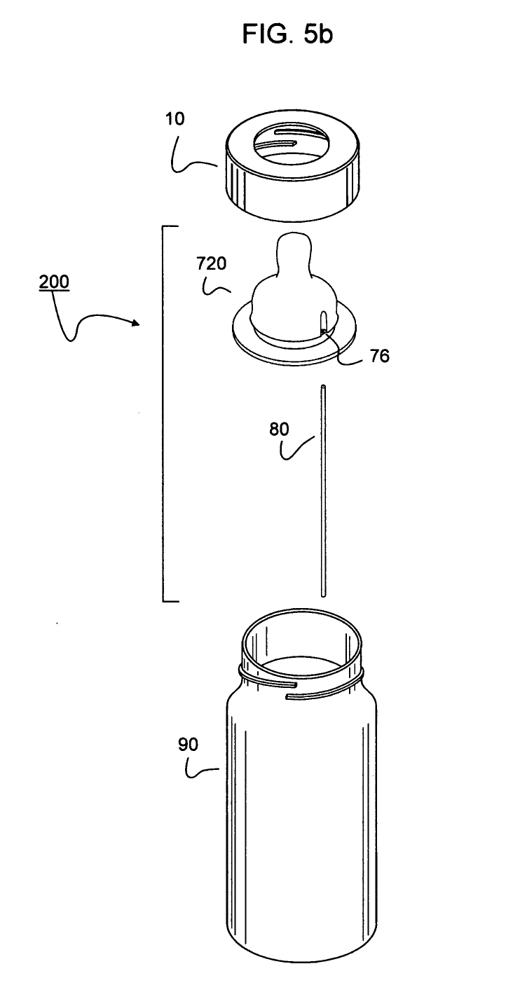

FIGS. 5a, 5b and 5c illustrate a section view, an upper perspective view and a bottom perspective view respectively of the vent system 200 in which the first end 80a of the tube 80 is secured in the aperture 76 within a thickness of an internal edge 24 of the modified nipple 720. The modified nipple 720 may include a recessed portion 74 disposed in an external side 26 of the modified nipple 720. The internal edge 24 may be built up thick enough to accommodate the aperture 76 and/or a standard size nipple 20 may be uniquely adapted in accordance with this invention to receive an aperture 76 through the thickness of the wall of the nipple 20. In use, atmospheric air is allowed to communicate with the inside of the infant nursing bottle 100 via the aperture 76 and the tube 80 into the interior of the bottle 100, while preventing the liquid within the bottle from escaping, under capillary action, through the vent system 200.

FIG. 5b shows an exploded upper perspective view of the vent system 200 in conjunction with a regular container 90.

FIG. 5c shows an exemplary embodiment of the vent system 200, in which the tube 80 may be secured at an angle through the aperture 76 to improve the anti-leaking properties of the vent system 200 as well as to enhance the free flow of fluid through the nipple 20 when the liquid in the infant nursing bottle 100 is dispensed and the infant nursing bottle 100 is tilted at a predetermined feeding angle.

FIGS. 6a, 6b and 6c illustrate a section view, an upper perspective view and a bottom perspective view respectively of an exemplary embodiment of the vent system 200 in which, the radial flange 22 of the nipple 20 is modified to include the aperture 76 through which the tube 80 is secured.

As shown, the flange 22 of a nipple 20 is uniquely adapted in accordance with this invention to include an aperture 76 disposed through a thickness in the wall is of the nipple 20, and into which the tube 80 is disposed. In use, atmospheric air is allowed to communicate with the inside of the infant nursing bottle 200 via the aperture 76 and the tube 80 into the interior of the bottle 200, while preventing the liquid within the bottle from escaping, under capillary action, through the vent system 200.

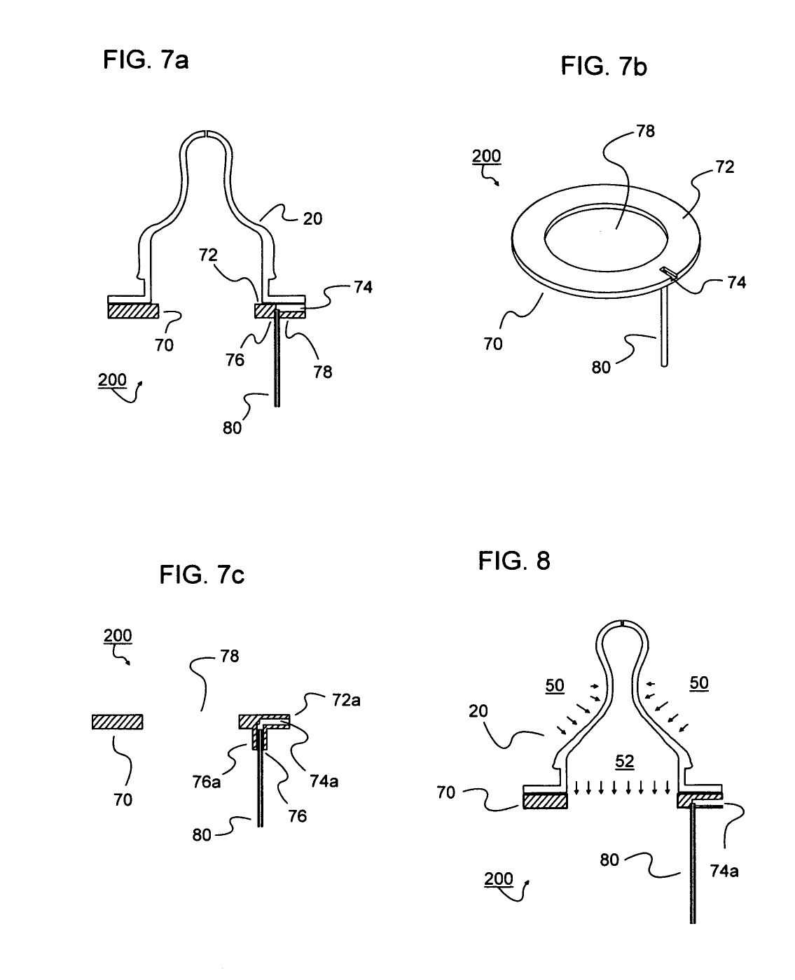

FIGS. 7a, 7b and 7c, show section views, and an upper perspective view, of yet another exemplary embodiment of the vent system 200 in which the properties and/or characteristics of the modified nipple 720 (shown in FIG. 5a) are integrated into a ring 70. The ring 70 is constructed to include aperture 76 to secure the tube 80, and a recessed portion 74 in the ring 70 adapted to provide communication of the atmospheric air back through the tube 80.

In FIG. 7a, a top surface 72 of the ring 70 illustrates the inclusion of an air inlet recessed portion 74 that allows atmospheric air to communicate into the bottle 30. That is, atmospheric air communicates through the inlet recessed portion 74 and back into the tube 80 disposed in the aperture 76, and back into the bottle 30.

FIG. 7c demonstrates another alternative exemplary embodiment for the vent system 200. As shown, a ring 70 includes a holder tube 76a projection having an aperture 76 disposed therein into which a tube 80 is secured. A cavity 74a is disposed through an end wall, or side surface 72a of the ring 70. The cavity 74a opens into the aperture 76, and together the cavity 74a and the aperture 76, form a channel through the ring 70 that allows atmospheric air to travel there-through. The holder tube 76a efficiently secures the tube 80 to the ring 70.

In FIG. 8, an exemplary back flow 52 pressure is demonstrated within the vent system 200. As shown, the exemplary back flow 52 pressure can create an increased amount of over pressure inside the container which may overcome the desired capillary properties of the tube 80. Consequently, the free flow of liquid is restricted and/or prevented such that the free flow of the liquid cannot escape through the vent system 200 as result of an increased external pressure 50 applied over the nipple 20.

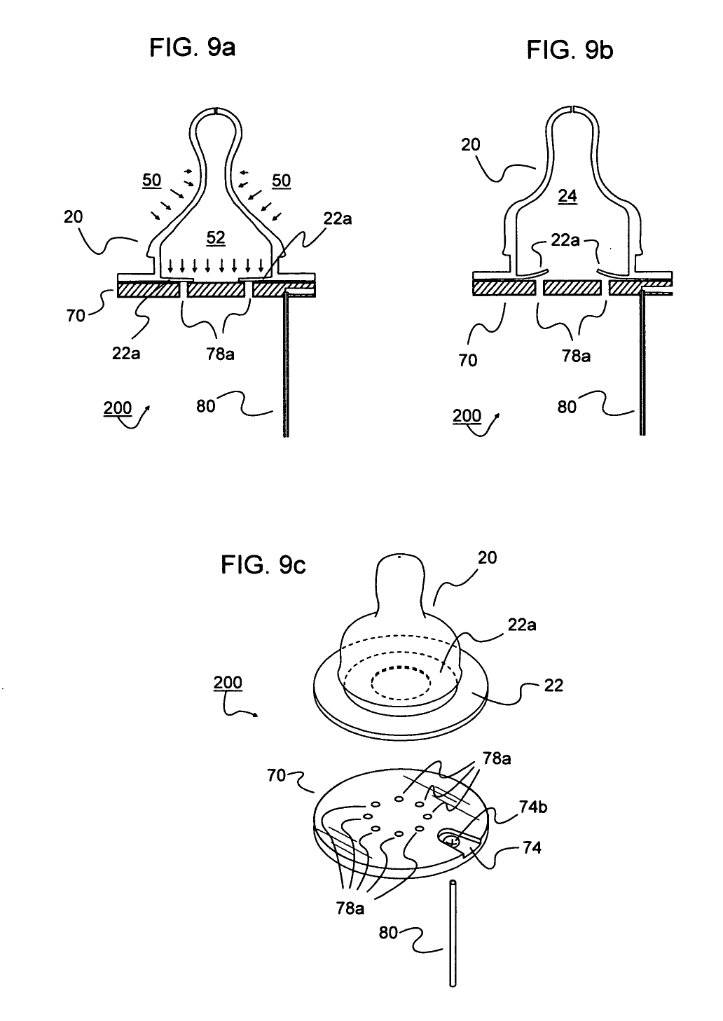

FIGS. 9a-9c show a section views and an upper perspective view of an embodiment of the vent system 200 in which an inwardly disposed flap ring 22a is included in the nipple 20 to improve the anti-leaking properties of the vent system 200.

FIG. 9a shows the flap ring 22a seated against the ring 70 in a closed position stopping any back pressure 52 from being forced into the container as result of an applied external pressure 50. As shown, a plurality of ring passageways 78a (as shown in FIGS. 9a-9c) may be provided to replace a main hole 78 (such as shown in FIG. 7c). FIG. 9b shows the flap ring 22a of the nipple 20 in an opened position allowing communication of the passageways 78a disposed in the ring 70 and a nipple area 24 to allow the free flow of the flowable material in a direction toward the dispensing end of the nipple 20, but not in a reverse direction.

FIG. 9c demonstrates another exemplary embodiment for the vent system 200 in which a valve 74b is included in the ring 70 that prevents the escape of any liquid inside the infant nursing bottle 100 through the recessed portion 74. The valve 74b will prevent the escape of any liquid or substance when the tube 80 is missing and/or not being used according to this exemplary embodiment. Alternatively, the valve 74b may be incorporated in the modified nipple 720 to prevent the escape of the liquid inside the container through the vent system 200.

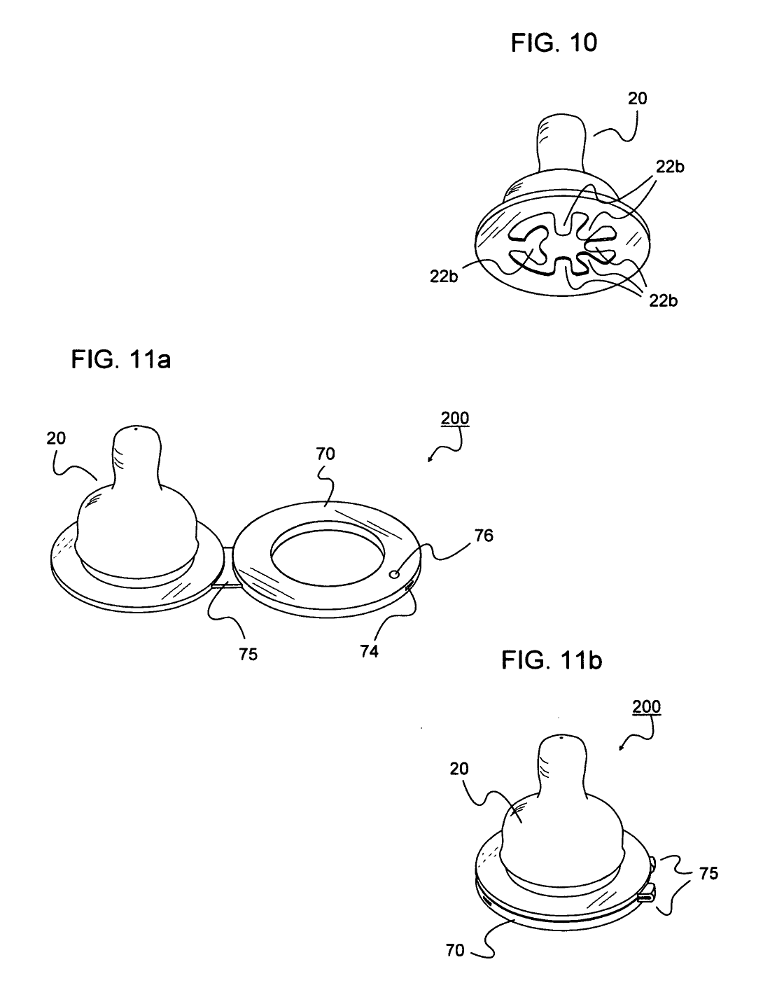

FIG. 10 shows a bottom perspective view of a nipple 20 in which (in an alternative to the flap ring 22a shown in FIG. 9c) a variety of flaps 22b are constructed at the lower end of the nipple 20, and adapted to cover the plurality of ring passageways 78a (as shown for example in FIG. 9c) disposed in a ring 70 or the like. The various flaps 22b on the nipple 20 would functionally operate similar to the flap ring 22a in FIGS. 9a-9c.

FIGS. 11a and 11b illustrate another exemplary embodiment for the vent system 200 in which a flange 75 is constructed to integrate a nipple 20 and a ring 70 as a single-piece construction assembly. FIG. 11a illustrates the nipple 20 and the ring 70 connected by a flange 75 in an open arrangement. The aperture 76 and the recessed portion 74 are shown in the ring 70.

FIG. 11b demonstrates the nipple 20 and the ring 70 connected by a flange 75 in a closed assembled configuration for use. In FIG. 11b, the flange 75 is constructed as a dual-webbed connection fastened at a first end to the nipple 20 and at a second end to the ring 70. The recessed portion 74 is shown in the ring 70. Various advantages are provided by this unitary construction integrating the ring 7 with the nipple 20. For example, the ring 7 and the nipple 20 of the vent system 200 are easier to keep track of and likewise easy to wash and install when in use.

Although various exemplary embodiments are shown above, it is to be understood that these examples should not be construed as limiting the scope of the invention but as merely providing illustrations of some of the preferred embodiments of the invention. For example: All parts described can be made of different sizes and/or figures. Parts and/or sections of parts can be mixed and/or adapted to other parts to create another parts and/or be separated in different parts.

It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

1. A vent system for a dispenser, comprising:
a nipple secured to the dispenser; and
a capillary tube disposed within an aperture that allows atmospheric air to pass there-into the dispenser, and prevents moisture from escaping there-out of the dispenser.

2. The vent system recited in claim 1, further comprising a ring disposed adjacent to the nipple and secured to the dispenser.

3. The vent system recited in claim 1, wherein the aperture is disposed within a wall of the nipple and the capillary tube is positioned within the aperture.

4. The vent system recited in claim 2, wherein the aperture is disposed within a wall of the ring and the capillary tube is positioned within the aperture.

5. The vent system recited in claim 3, wherein a recessed portion is disposed within a thickness of the wall of the nipple and wherein the recessed portion communicates with the aperture disposed within the wall of the nipple.

6. The vent system recited in claim 4, wherein the capillary tube is disposed within the aperture disposed within a thickness in the wall of the ring and a recessed portion is disposed within a thickness of the wall of the nipple and wherein the recessed portion communicates with the aperture disposed within the wall of the ring.

7. The vent system recited in claim 4, wherein a recessed portion is disposed within the thickness of the wall of the ring and wherein the recessed portion communicates with the aperture disposed within the wall of the ring.

8. The vent system recited in claim 2, wherein the nipple includes an inward flange portion or a plurality of inward flange portions that extends over a plurality of passageways or a passageways disposed within the thickness of the ring, and wherein the inward flange portion is provided to seal off the plurality of passageways or the passageways when an increased back pressure is exerted from outside of the dispenser inward over the nipple.

9. The vent system recited in claim 3, wherein the aperture communicates to a valve provided to prevent liquid from escaping out of the dispenser through the aperture.

10. The vent system recited in claim 3, wherein the aperture is received within a projection portion and into which the capillary tube is received.

11. The vent system recited in claim 2, wherein the nipple and the ring are attached by a flange or a plurality of flanges as a unitary construction.

12. A vent system for a bottle dispenser, comprising:
a nipple;
a ring disposed adjacent to the nipple and secured to the dispenser by a collar; and
a capillary tube disposed in an aperture that allows atmospheric air to pass into the dispenser, and prevents moisture from escaping out of the dispenser.

13. The vent system recited in claim 12, wherein the aperture is disposed within a thickness in a wall of the nipple and the capillary tube is disposed within the aperture.

14. The vent system recited in claim 12, wherein the aperture is disposed within a thickness in a wall of the ring and the capillary tube is disposed within the aperture.

15. The vent system recited in claim 13, wherein a recessed portion is disposed within the thickness of the wall of the nipple and wherein the recessed portion communicates with the aperture.

16. The vent system recited in claim 4, wherein the aperture communicates to a valve provided to prevent liquid from escaping out of the dispenser through the aperture.

17. The vent system recited in claim 4, wherein the aperture is received within a projection portion that extends into the dispenser, and into which the capillary tube is received.
